(19) United States
(12) Patent Application Publication
(10) Pub. No.: US 2006/0153288 A1
(43) Pub. Date: Jul. 13, 2006

(54) Method for compressing and decompressing video image data

(75) Inventor: Uwe Prochnow, Essen (DE)

Correspondence Address: BROWDY AND NEIMARK, P.L.L.C.;624 NINTH STREET, NW, SUITE 300, WASHINGTON, DC, 20001-5303, US

(73) Assignee: Atvisican AG, Essen (DE)

(21) Appl. No.: 10/521,116

(22) PCT Filed: Jul. 10, 2003
(86) PCT No.: PCT/EP03/07451

§ 371 Date: Sep. 23, 2005

(30) Foreign Application Priority Data
Jul. 12, 2002 (DE) 102 31 613.9

(51) Int. Cl. H04N 11/04; G06K 9/36; H04N 7/12; H04N 11/02; H04B 1/66

(52) U.S. Cl. 375/240.01; 382/232

(57) ABSTRACT

A method for compressing and decompressing video image date, wherein the contours of image structures are determined in a basic analysis of the video data contained in a video image by means of sudden modifications of brightness and/or tristimulus value in adjacent pixels; the contours thus found are respectively described in segments by means of a parameterized mathematical function and are defined as objects; a color dominance and a color characteristic is determined for the individual objects, in addition to the position and extension of the individual objects and a structural function, such that differential modification in brightness, size, position and orientation of said objects are determined in sequential analyses of video images, taking into account common contours of contiguous objects. The objects thus defined are placed in a structured base frame or sequential frame and are prepared. Contour analysis and structural analysis is carried out by means of neuronal networks.

The invention relates to a method for compressing and decompressing video image data of video image sequences or the like, which are present as a sequence of in each case in two-dimensionally addressable pixels of associated pixel data ¹, wherein in each case the pixel data of selected pixel quantities are analyzed with mathematical functions and compressed reduced to their function parameters and after storage and/or transmission are decompressed with a corresponding mathematical function such that they are largely regenerated.
¹ Translator's note: This literal translation of this sentence clause is based on a sentence clause with incoherent grammar in the German-language source document.

Such methods have become known under the ISO standards MPEG, MPEG1 to MPEG4, JPEG, etc. In the case of these, function parameters are determined through a differential analysis, pattern analysis, Fourier analysis or the like of the pixel quantity data of image segments, so-called tiles, and in particular of such tile data in relation to the tile data of the tile with the same image line coordinates and image column coordinates of preceding video images, and, taking into account changes in these video image sequences, are represented in accordance with agreed standard frame formats. The frame formats in each case contain a statement of the corresponding compression function, which in each case is selected to compress more extensively the more strongly the content of consecutive images or tiles in the same position in such images agree, and the parameters that are obtained in the use of the function in each case.

For decompression, the information regarding the given compression function is taken from the frame in each case, and according to it, by means of a corresponding function and the parameters provided, as well as possibly data of the tile(s) of at least one preceding image, the original pixel quantity is restored, to within a margin of tolerance.

The object of the invention is to provide significantly greater compression of the data in real time passage of video image sequence data with approximately the same image quality as the known methods.

This object is met in such a way that in a basic analysis of the video data of a video image
contours of image structures are determined on the basis of non-sequential changes in brightness and/or color value in the case of pixels that are adjacent to one another,
through interpolation, a smoothing and closure of contours is performed,
the contours that are found in this way are described in segments in each case through a parameterized mathematical function and are defined as objects, wherein all objects that contain a number of pixels below a predefinable threshold are assigned to a background,
for the individual objects and the background a color dominance and color progression is determined vectorially in each case according to direction and size,
the position and extent of the individual objects are determined vectorially in each case,
for the individual objects and the background, a structure function is determined in each case,
and that in the case of sequence analyses of video images,
in each case the differential changes in brightness, size, position and orientation of the objects are determined, taking into account the common contours of objects that abut one another,
the objects and the background that are defined in this way, together with their optical, positional and structural data that are obtained in this way, are arranged and provided in a structured basic frame or sequence frame,
the basic frame data and sequence frame data that are provided accordingly are transformed into pixel data for decompression and image re-processing,
in that from the basic frame data from the objects, their corresponding contour position data in the pixel image are determined,
for the background of the image and the objects, respectively delimited on the basis of the contour position data, the pixel representation are [sic] filled up with pixel data corresponding to the given associated structure function,
which are reconstituted in accordance with the color dominance value and the color progression vector as well as the brightness value, and
the sequence frame data are applied in each case to the previous pixel representation for displacement and/or alteration of the objects.

Advantageous embodiments are defined in the subclaims.

The determination and description of the objects on the basis of their contours and their structures leads to the extremely high data compression in comparison to the conventional methods, in which individual rectangular segment [sic] are processed in each case, without detecting and utilizing a larger pictorial connection.

To accelerate the process, advantageous innovative methods, which are also to be regarded as autonomous inventions, are additionally applied in the individual process steps.

On the basis of the knowledge that many objects are similar to others in terms of their basic structure and their relation to others, e.g. head, arms, upper body, lower body, legs to a person etc., objects that have once been recognized and characterized in terms of function are stored on the basis of their data in a neural network, assigned to its other and corresponding objects contour data ², so that in each case for a found object, objects that usually adjoin them can later be located directly and applied for facilitating contour determination.
² Translator's note: This literal translation is based on a sentence clause with incoherent grammar in the German-language source document.

Also, the compilations of the mathematical function descriptions of the various objects can be taken from the neural network, which need to be labeled only with corresponding current parameters such as radius, mid-point vector, start and end co-ordinates etc.

Also, the structure function of an object is frequently the same as or close to that of similar objects, so that it can serve as a first approximation if it is stored in the neural network and is taken from it.

Advantageously, very high compression is achieved through utilization of the knowledge that the pixel data of a pixel line is a series of numbers in each case, which can be represented by elementary arithmetic operations that are carried out with natural numbers. In particular, division and the nth root are simple operations that more or less yield periodic pixel data of a line with a good approximation. The representation of the line then shrinks to the encrypted statement of the function and the numeric quantities, which are preferably shown as a sum or differences of prime number powers.

Every such structure description that has already been located for a pixel data sequence is preferably stored in a neural network, so that it is immediately usable there or can be called up as a first approximation when a similar pixel data sequence is later present.

Since the functions to be used are elementary and can be carried out by conventional computers at high speed as fixed point operations, the pixel data can be generated from the structure data in the run time of an image reproduction; decompression is completely unproblematic.

In terms of its precision, the compression of video run time data is, advantageously, adapted in its individual steps to the compatibility of deviations.

In determining the contour data, smoothing etc., more attention is paid to a high resolution of foreground objects that are in motion than to the background and the passive objects in that different maximum computing times are accorded to objects for processing in each case.

Additionally, the minimum number of pixels for which an object is defined is adapted in each case to computing time that is still available. The largest objects are processed first, and where there is still computing time left for image time, smaller objects are separated out of the background and described in detail, geometrically and structurally, and placed into the frame.

For determining a structure function of an object, a maximum time specification is advantageously made in each case, wherein use is made of the knowledge that deviations of the individual pixel data, if they do not occur in quantity adjacent to one another, do not result in any notable worsening of image quality, since the structure relates only to the general appearance of the surface of an object, but not to any image details.

For illustration, let us take the following as an example of a structure function:

The xth root of a to the power of m+/−b to the power of n divided by c to the power of p+/−d to the power of q; x=whole-number 1÷3; a, b, c, d=prime numbers up to 17; m, n, p, q=whole-number 1÷9.

As the pixel quantity that is to be analyzed, let us take for example 256 pixels in each case of an image line segment or of an 8×8 or 16×1 6 pixel image segment. The pixel data are customarily encrypted in 8-bit. Accordingly, the operations are executed not decimally or hexadecimally, but in modulo 256, so that the source data, like the encryption data and the regained target data, are always directly present as 8-bit pixel data.

If several line segments of an image line or consecutive image lines are analyzed, a suitable solution often results, in a very simple and time-saving manner, from a continuation and/or a displacement by several places of the previously applicable structure function. Instead of a new structure function, the modification is stated in the associated frame.

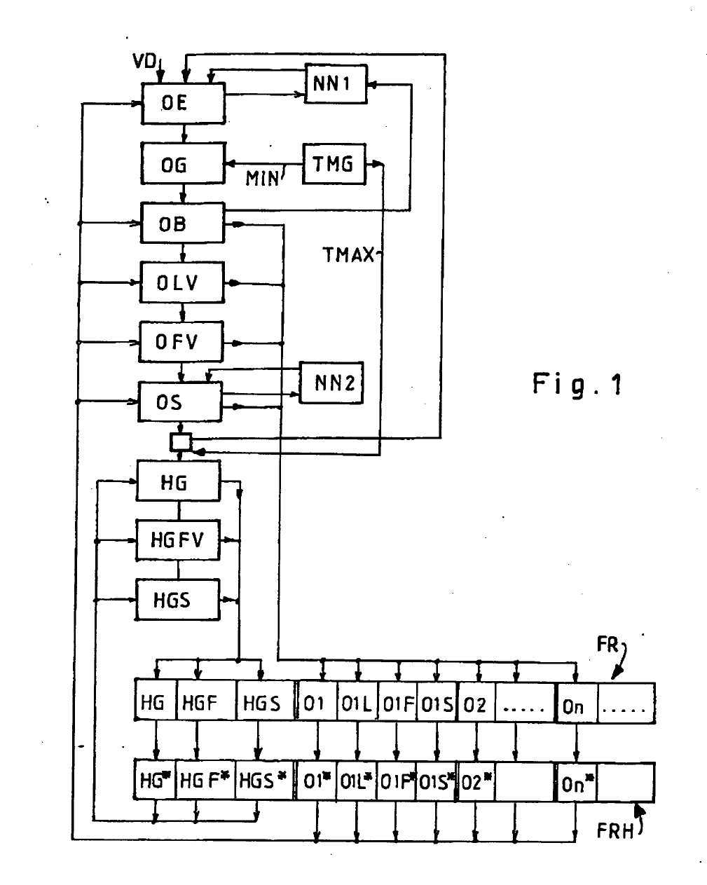

FIG. 1 shows a block diagram of the image encryption.

The video data VD are gradually subjected to the various process steps.

First, there is the object recognition OE, wherein the objects 01*; 02* that have previously been recognized in the image, as well as the objects stored in a first neural network NN1 are used as auxiliary information. The recognized objects are subjected to object smoothing OG, with a specified resolution limit MIN.

The smoothed objects undergo object description, taking into account the neighborhood limit relations, so that the objects O1, O2 etc. are stored functionally in the frame FR.

For the individual objects, the establishment OLV of the positional and directional vectors OL1, OL2 etc. takes place, as well as the color description OFV by means of the color vectors and color progression vectors OF1, OF2 etc.

Additionally, for the objects O1, O2 etc. the structure functions and their parameters OS1, OS2 etc. are determined, preferably with the aid of a second neural network NN2, and are placed in the frame FR, just like the positional and color vectors.

Once all the objects are recorded in the frame, the color vectors HGF and the background structures HGS are determined from the background HG, and placed in the frame FR. A complete frame FR of an image is then provided as a historical frame FRH, whose contents, which are marked by a star on the reference symbol in each case, are made available to the encryption of the next image as starting material.

If only slight changes to the color, position, structure or orientation of an object is [sic] established, then only the changes are specified in the subsequent frame, which yields a considerable savings in processing time, storage and transmission capacity.

Given object descriptions that are located, their neighborhood relations as well as the structure functions, are supplied to the bases of the neural networks NN1, NN2, so that similar objects and structures are located and used in the encryption of new images.

The encryption time is monitored in each case via a time manager TMG, and is held within limits through appropriate specifications of the minimum resolution MIN and the maximum time TMAx of the structure analysis.

An alternative to the calculation of the structure functions as described above can be performed similarly advantageously with hexadecimal operations, for which the usual 8-bit pixel information is split into two 4-bit characters, and thus double the number of places is calculated and checked for the greatest possible similarity. The functions and their parameters are expediently, in particular in that connection, also encrypted as hexadecimal digits and packed in pairs in 8-bit bytes in the frame. Depending on the stated function, more or fewer parameters are to be stated.

A very high packing density in the frame can also be achieved if, in a byte, in each case three bits are stored for eight functions, three bits for the eight first prime numbers, and two bits for their exponents from 1-4. For example, the four fundamental operations, the root and power functions, as well as formula parenthesis can be encrypted as function elements. For the parenthetical functions, additional special functions, such as formula end character or complex functions, may be stated in the other 5 bits of the byte.

What is claimed is:

1. A method for compressing and decompressing video image data of video image sequences or the like, which are present as a sequence of in each case in two-dimensionally addressable pixels of associated pixel data ³, wherein in each case the pixel data of selected pixel quantities are analyzed with mathematical functions and are compressed reduced to their function parameters and after storage and/or transmission are decompressed with a corresponding mathematical function such that they are largely regenerated, characterized in that in a basic analysis of the video data of a video image
contours of image structures are determined on the basis of non-sequential changes in brightness and/or color value in the case of pixels that are adjacent to one another,
through interpolation, a smoothing and closure of contours is performed,
the contours that are found in this way are described in segments in each case through a parameterized mathematical function and are defined as objects, wherein all objects that contain a number of pixels below a predefinable threshold are assigned to a background,
for the individual objects and the background a color dominance and color progression is determined vectorially in each case,
the position and extent of the individual objects are determined vectorially in each case,
for the individual objects and the background, a structure function is determined in each case according to direction and size,
and that in the case of sequence analyses of video images,
in each case the differential changes in brightness, size, position and orientation of the objects are determined, taking into account the common contours of objects that abut one another,
the objects and the background that are defined in this way, together with their optical, positional and structural data that are obtained in this way, are arranged and provided in a structured basic frame or sequence frame,
the basic frame data and sequence frame data that are provided accordingly are transformed into pixel data for decompression and image re-processing,
in that from the basic frame data from the objects, their corresponding contour position data in the pixel image are determined,
for the background of the image and the objects, respectively delimited on the basis of the contour position data, the pixel representation are [sic] filled up with pixel data corresponding to the given associated structure function,
which are reconstituted in accordance with the color dominance value and the color progression vector as well as the brightness value, and
the sequence frame data are applied in each case to the previous pixel representation for displacement and/or alteration
³ Translator's note: This literal translation of this sentence clause is based on a sentence clause with incoherent grammar in the German-language source document.

2. A method according to claim 1, characterized in that the objects described are stored with their mathematical functions in a neural network (NN1), which serves for the further recognition (OE) of objects in video image data (VD).

3. A method in accordance with any of the above claims, characterized in that structure functions (OS) that have been determined are stored with their parameters of objects and backgrounds in a neural network (NN2), which serves as a starting basis in the further determination of structure functions (OS) with their parameters.

4. A method in accordance with any of the above claims, characterized in that the structure function (OS) is represented in each case as a mathematical function and the parameters are whole-number values and the function provides an unlimited number of places after the decimal point.

5. A method in accordance with claim 4, characterized in that the structure function (OS) is a fraction, an nth root or a transcendental function.

6. A method in accordance with claim 4 or 5, characterized in that the whole-number values are represented, encrypted, as powers of prime numbers as well as sums or difference thereof.

7. A method in accordance with any of claims 4 to 6, characterized in that the parameters are represented as modulo 2 to the power of 8, and the function are [sic] executed with quantities that are represented as modulo 2 to the power of 8, and provide such quantities as places after the decimal point.

8. A method in accordance with any of the claims 4 to 7, characterized in that the individual structure functions (OS) are determined in each case approximately matching to a pixel data sequence of an image line segment of predefined length or of a rectangular pixel image segment.

9. A method in accordance with claim 8, characterized in that the line segment has a length of 64, 128 or 256 bytes or the pixel image segment has a size of 8 times 8 or 16 times 16 bytes.

10. A method in accordance with one of the claims 8 or 9, characterized in that the structure function (OS) is adapted in each case as long or as precisely through successive approximation to the pixel data sequence that is to be approximately represented in each case, which is determined by a time specification (TMax) or an accuracy specification.

11. A method in accordance with claim 10, characterized in that the time specification or accuracy specification is determined depending on the position or a given speed of change of position of the given object, wherein for objects lying and/or resting centrally in the image, a longer time and/or a higher level of accuracy is assigned than for objects at the edge and/or objects that are in relatively fast motion and/or for the background.

12. A method in accordance with any of the preceding claims, characterized in that in each case only those objects are subjected to further identification and characterization that have a minimum number of pixels, and smaller objects are assigned to the background.

13. A method in accordance with claim 12, characterized in that the objects are processed one after another with a decreasing number of pixels as long as the available computing time allows, through which in the encryption of an image content, the minimum number of pixels of the objects is determined according to the available computing time.
